(19) United States
(12) Patent Application Publication
(10) Pub. No.: US 2012/0208155 A1
(43) Pub. Date: Aug. 16, 2012

(54) Potty Training Method

(76) Inventor: Daniel Deleo, Milton, MA (US)

(21) Appl. No.: 13/371,386

(22) Filed: Feb. 10, 2012

Related U.S. Application Data
(60) Provisional application No. 61/441,394, filed on Feb. 10, 2011.

(51) Int. Cl. G09B 19/00

(52) U.S. Cl. 434/236

(57) ABSTRACT

A method for potty training a child on a standard flush toilet or a children's training toilet. That includes a device that may be placed almost anywhere on the toilet. The device contains a button that generates a sound, a light, a vibration, or a combination thereof when pressed. The child is taught to press this button as a reward for successfully using the toilet. The device may contain transmitters for transmitting to computing devices the number of times the button is pressed. These transmissions allow a supervising adult to monitor the progress of a child's toilet training by the number of times the button on the device is pressed.

### CROSS REFERENCE TO RELATED APPLICATION

This application claims the benefit of U.S. Provisional Patent Application No. 61/441,394 filed on Feb. 10, 2011, the contents of which are incorporated herein by reference.

### FIELD OF THE INVENTION

This invention relates to a novel method for training small children how to regularly use a standard flush toilet or child-sized potty chair.

### BACKGROUND OF INVENTION

Small children, usually beginning at ages 2 to 3, show an interest in using a standard flush toilet. Adults raising these children must “potty train” them to properly use the toilet. This training process can be long and frustrating for the small children and the adults. Reducing this training time and frustration can increase the successful results of small children.

To reduce the frustration and time of this potty training, many different devices and techniques have been developed.

One technique is to provide small children with smaller models of toilets or potty chairs. The first stage of training begins on these potty chairs. The second stage of training involves removing the removable top of these potty chairs and placing the potty chair directly on a standard flush toilet. The third stage of training involves removing the potty chair and training the child directly on the standard flush toilet.

This technique has several drawbacks. First, different potty chairs must be developed for different sized children, and for children with physical disabilities. Second, not all potty chairs will sit directly in differently shaped toilets for stage 2 of this technique. This presents the problem of either skipping the second stage or starting the first stage all over again with a proper shaped potty chair.

Furthermore, many training techniques recommend providing praise to the child for trying, even if unsuccessful. Some techniques recommend giving the child a special toy to aid in training. Other techniques recommend other rewards, such as placing stickers on a chart, trips to the park or extra bedtime stories.

There exists a need for a potty training method that is easy for adults to implement and easy for children to understand and follow. This method will be simple to use and will allow parents to begin training their children on a standard flush toilet or child's potty chair. This method will also reduce training time and will offer immediate praise to the child to increase training efficiency.

For a better understanding of the invention, its operating advantages and the specific objects attained by its uses, reference should be made to the accompanying drawings and descriptive matter in which there are illustrated embodiments of the invention. Other features and advantages of the present invention will become apparent from the following description of the embodiment(s), taken in conjunction with the accompanying drawings, which illustrate, by way of example, the principles of the invention.

### SUMMARY OF THE INVENTION

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

The subject invention discloses a method for toilet training a child comprising the steps of: a) providing a flush toilet comprising at least one exterior flat surface, and a toilet bowl having toilet bowl water therein; b) placing a portable, handheld annunciating device on the exterior flat surface of the flush toilet, wherein the annunciating device comprises a housing, a substantially flat bottom surface and a user-actuated button on the top surface, further wherein the substantially flat bottom surface comprises means for removably attaching the annunciating device to the exterior flat surface of the flush toilet; c) allowing the child to attempt to urinate or defecate into the toilet; d) allowing the child to press the user-actuated button on the annunciating device after the attempt, wherein pressing the button transmits a signal to an operationally coupled circuit contained within the annunciating device to activate an internal annunciator; and e) providing a positive training stimulus to the child being trained by an adult person observing the child attempting to use the toilet.

In another embodiment of the subject invention, the annunciating device may contain an internal power source electrically coupled to the circuit and the internal annunciator. In embodiments of the subject invention, the internal power source may be a battery.

In a further embodiment of the subject invention, the internal annunciator may be an audible transducer, a visual transducer, a tactile transducer or any combination thereof. In other embodiments of the subject invention, the visual transducer may be a light emitting diode.

In one embodiment of the subject invention, the annunciating device may have an external switch operationally coupled to the circuit, wherein the switch allows a user to select whether the audible transducer, visual transducer, tactile transducer, or any combination of these three is activated once the user-actuated button is pressed.

In a further embodiment of the subject invention, the internal annunciator may emit a song, tone, ring, or a recorded message. The audio sound is intended to be amusing, encouraging, and re-affirming to the small child. In another embodiment of the subject invention, the annunciating device may have an external volume control switch or dial operationally coupled to the internal annunciator.

In another embodiment of the subject invention, the housing may contain a small internal microphone for recording a sound onto the internal annunciator to be stored as a software audio file to be emitted by the internal annunciator.

A further embodiment of the subject invention, the method further comprises the steps of: f) wirelessly transmitting a signal from a wireless transmitter operationally coupled to the circuit each time the user-actuated button is pushed, to an electronic storage medium; g) storing the number of times the user-actuated button is pushed on the electronic storage medium; h) processing the number of times the user-actuated button is pushed with a processor operationally coupled to the electronic storage medium; i) generating a user-designed chart illustrating the number of time the user-actuated button is pushed; and j) monitoring these times to determine the success rate of the child.

In this embodiment of the subject invention, the electronic storage medium and processor may be a computer, a mobile computer pad, or a mobile smart phone.

Another embodiment of the subject invention is a method for toilet training a child comprising the steps of: a) providing a child training toilet comprising at least one exterior flat surface; b) placing a portable, handheld annunciating device on the exterior flat surface of the training toilet, wherein the annunciating device comprises a housing, a substantially flat bottom surface and a user-actuated button on the top surface, further wherein the substantially flat bottom surface comprises means for removably attaching the annunciating device to the exterior flat surface of the training toilet; c) allowing the child to attempt to urinate or defecate into the training toilet; d) allowing the child to press the user-actuated button on the annunciating device after the attempt, wherein pressing the button transmits a signal to an operationally coupled circuit contained within the annunciating device to activate an internal annunciator; and e) providing a positive training stimulus to the child being trained by an adult person observing the child attempting to use the training toilet.

In another embodiment of the subject invention, the annunciating device may contain an internal power source electrically coupled to the circuit and the internal annunciator. In embodiments of the subject invention, the internal power source may be a battery.

In a further embodiment of the subject invention, the internal annunciator may be an audible transducer, a visual transducer, a tactile transducer or any combination thereof. In other embodiments of the subject invention, the visual transducer may be a light emitting diode.

In another embodiment of the subject invention, the annunciating device may have an external switch operationally coupled to the circuit, wherein the switch allows a user to select whether the audible transducer, visual transducer, tactile transducer, or any combination of these three is activated once the user-actuated button is pressed.

In a further embodiment of the subject invention, further comprising the steps of: f) wirelessly transmitting a signal from a wireless transmitter operationally coupled to the circuit each time the user-actuated button is pushed, to an electronic storage medium; g) storing the number of times the user-actuated button is pushed on the electronic storage medium; h) processing the number of times the user-actuated button is pushed with a processor operationally coupled to the electronic storage medium; i) generating a user-designed chart illustrating the number of time the user-actuated button is pushed; and j) monitoring these times to determine the success rate of the child.

In this embodiment of the subject invention, the electronic storage medium and processor may be a computer, a mobile computer pad, or a mobile smart phone.

A further embodiment of the subject invention is a method for toilet training a child comprising the steps of: a) providing a flush toilet comprising at least one exterior flat surface, and a toilet bowl having toilet bowl water therein; b) placing a portable, handheld electronic device on the exterior flat surface of the flush toilet, wherein the electronic device comprises a housing, a substantially flat bottom surface and a user-actuated button on the top surface, further wherein the substantially flat bottom surface comprises means for removably attaching the electronic device to the exterior flat surface of the flush toilet; c) allowing the child to attempt to urinate or defecate into the toilet; d) allowing the child to press the user-actuated button on the electronic device after the attempt, wherein pressing the button transmits a signal to an operationally coupled controller contained within the electronic device to activate an internal sensory output generator, wherein the sensory output generator generates a sensory output; and e) providing a positive training stimulus to the child being trained by an adult person observing the child attempting to use the toilet.

In other embodiments of the subject invention, the electronic device may contain an internal power source electrically coupled to the controller and the sensory output generator. In embodiments of the subject invention, the internal power source may be a battery.

In further embodiments of the subject invention, the sensory output generator may be an audible transducer, a visual transducer, a tactile transducer or any combination thereof. In other embodiments of the subject invention, the visual transducer may be a light emitting diode.

In a further embodiment of the subject invention, the electronic device may have an external switch operationally coupled to the circuit, wherein the switch allows a user to select whether the audible transducer, visual transducer, tactile transducer, or any combination of these three is activated once the user-actuated button is pressed.

In another embodiment of the subject invention, further comprising the steps of: f) wirelessly transmitting a signal from a wireless transmitter operationally coupled to the controller each time the user-actuated button is pushed, to an electronic storage medium; g) storing the number of times the user-actuated button is pushed on the electronic storage medium; h) processing the number of times the user-actuated button is pushed with a processor operationally coupled to the electronic storage medium; i) generating a user-designed chart illustrating the number of time the user-actuated button is pushed; and j) monitoring these times to determine the success rate of the child.

In this embodiment of the subject invention, the electronic storage medium and processor may be a computer, a mobile computer pad, or a mobile smart phone.

The subject invention further discloses a method for toilet training a child comprising the steps of: a) providing a flush toilet comprising at least one exterior flat surface, and a toilet bowl having toilet bowl water therein; b) providing a portable, handheld electronic device, wherein the electronic device comprises a housing, a substantially flat bottom surface and a user-actuated button on the top surface, further wherein the substantially flat bottom surface comprises means for removably attaching the electronic device to the exterior flat surface of the flush toilet; c) visually presenting and demonstrating the electronic device to the child by pressing the user-actuated button within the child's sight, wherein pressing the button transmits a signal to an operationally coupled controller contained within the housing to activate an internal sensory output generator, wherein the sensory output generator generates a sensory output to the child; d) allowing the child to press the user-actuated button on the electronic device to activate the internal sensory output generator to generate the sensory output for the child; e) repeating steps c) and d) until the child associates the sensory output with pressing the user-actuated button; f) placing the electronic device on the exterior flat surface of the flush toilet with the means for removably attaching the electronic device, wherein the electronic device is placed so as to allow the child to press the user-actuated button; g) encouraging the child to press the user-actuated button only upon completed urination or defecation into the toilet; h) allowing the child to attempt to urinate or defecate into the toilet when the child has the next urge to urinate or defecate; i) denying the child access to the user-actuated button except upon completion of urination or defecation into the toilet; j) allowing the child to press the user-actuated button on the electronic device after the attempt; and k) providing a positive training stimulus to the child after the attempt to urinate or defecate into the toilet.

In a further embodiment of the subject invention, the method further comprises the steps of: l) wirelessly transmitting a signal from wireless transmitter operationally coupled to the controller each time the user-actuated button is pushed, to an electronic storage medium; m) storing the number of times the user-actuated button is pushed on the electronic storage medium; n) processing the number of times the user-actuated button is pushed with a processor operationally coupled to the electronic storage medium; o) generating a user-designed chart illustrating the number of time the user-actuated button is pushed; and p) monitoring these times to determine the success rate of the child.

In this embodiment of the subject invention, the electronic storage medium and processor may be a computer, a mobile computer pad, or a mobile smart phone.

In other embodiments of the subject invention, the electronic device may contain an internal power source electrically coupled to the controller and the sensory output generator. In embodiments of the subject invention, the internal power source may be a battery.

In further embodiments of the subject invention, the sensory output generator may be an audible transducer, a visual transducer, a tactile transducer or any combination thereof. In other embodiments of the subject invention, the visual transducer may be a light emitting diode.

In a further embodiment of the subject invention, the electronic device may have an external switch operationally coupled to the controller, wherein the switch allows a user to select whether the audible transducer, visual transducer, tactile transducer, or any combination of these three is activated once the user-actuated button is pressed.

In one embodiment of the subject invention, the sensory output may be a song, tone, ring, or a recorded message. The audio sound is intended to be amusing, encouraging, and re-affirming to the small child. In another embodiment of the subject invention, the electronic device may have an external volume control switch or dial operationally coupled to the controller.

In another embodiment of the subject invention, the housing may contain a small internal microphone for recording a sound onto the controller to be stored as a software audio file to be emitted by the sensory output generator.

The subject invention also discloses a method for toilet training a child comprising the steps of: a) providing a child training toilet comprising at least one exterior flat surface; b) providing a portable, handheld electronic device, wherein the electronic device comprises a housing, a substantially flat bottom surface and a user-actuated button on the top surface, further wherein the substantially flat bottom surface comprises means for removably attaching the electronic device to the exterior flat surface of the training toilet; c) visually presenting and demonstrating the electronic device to the child by pressing the user-actuated button within the child's sight, wherein pressing the button transmits a signal to an operationally coupled controller contained within the housing to activate an internal sensory output generator, wherein the sensory output generator generates a sensory output to the child; d) allowing the child to press the user-actuated button on the electronic device to activate the internal sensory output generator to generate the sensory output; e) repeating steps c) and d) until the child associates the sensory output with pressing the user-actuated button; f) placing the electronic device on the exterior flat surface of the training toilet with the means for removably attaching the electronic device, wherein the electronic device is placed so as to allow the child to press the user-actuated button; g) encouraging the child to press the user-actuated button only upon completed urination or defecation into the training toilet; h) allowing the child to attempt to urinate or defecate into the training toilet when the child has the next urge to urinate or defecate; i) denying the child access to the user-actuated button except upon completion of urination or defecation into the training toilet; j) allowing the child to press the user-actuated button on the electronic device after the attempt; and k) providing a positive training stimulus to the child after the attempt to urinate or defecate into the training toilet.

In a further embodiment of the subject invention, the method further comprises the steps of: l) wirelessly transmitting a signal from wireless transmitter operationally coupled to the controller each time the user-actuated button is pushed, to an electronic storage medium; m) storing the number of times the user-actuated button is pushed on the electronic storage medium; n) processing the number of times the user-actuated button is pushed with a processor operationally coupled to the electronic storage medium; o) generating a user-designed chart illustrating the number of time the user-actuated button is pushed; and p) monitoring these times to determine the success rate of the child.

In this embodiment of the subject invention, the electronic storage medium and processor may be a computer, a mobile computer pad, or a mobile smart phone.

In other embodiments of the subject invention, the electronic device may contain an internal power source electrically coupled to the controller and the sensory output generator. In embodiments of the subject invention, the internal power source may be a battery.

In further embodiments of the subject invention, the sensory output generator may be an audible transducer, a visual transducer, a tactile transducer or any combination thereof. In other embodiments of the subject invention, the visual transducer may be a light emitting diode.

In another embodiment of the subject invention, the electronic device may have an external switch operationally coupled to the controller, wherein the switch allows a user to select whether the audible transducer, visual transducer, tactile transducer, or any combination of these three is activated once the user-actuated button is pressed.

The subject invention further discloses a method for toilet training a child comprising the steps of: a) providing a flush toilet comprising at least one exterior flat surface, and a toilet bowl having toilet bowl water therein; b) providing a portable, handheld annunciating device, wherein the annunciating device comprises a housing, a substantially flat bottom surface and a user-actuated button on the top surface, further wherein the substantially flat bottom surface comprises means for removably attaching the annunciating device to the exterior flat surface of the flush toilet; c) visually presenting and demonstrating the annunciating device to the child by pressing the user-actuated button within the child's sight, wherein pressing the button transmits a signal to an operationally coupled circuit contained within the housing to activate an internal annunciator to emit an audible sound for the child to hear; d) allowing the child to press the user-actuated button on the annunciating device to activate the internal annunciator to emit the audible sound for the child to hear; e) repeating steps c) and d) until the child associates the emitted audible sound with pressing the user-actuated button; f) placing the annunciating device on the exterior flat surface of the flush toilet with the means for removably attaching the annunciating device, wherein the annunciating device is placed so as to allow the child to press the user-actuated button; g) encouraging the child to press the user-actuated button only upon completed urination or defecation into the toilet; h) allowing the child to attempt to urinate or defecate into the toilet when the child has the next urge to urinate or defecate; i) denying the child access to the user-actuated button except upon completion of urination or defecation into the toilet; j) allowing the child to press the user-actuated button on the annunciating device after the attempt; and k) providing a positive training stimulus to the child after the attempt to urinate or defecate into the toilet.

In other embodiments of the subject invention, the annunciating device may contain an internal power source electrically coupled to the circuit and the internal annunciator. In embodiments of the subject invention, the internal power source may be a battery.

In further embodiments of the subject invention, the internal annunciator may be an audible transducer.

In a further embodiment of the subject invention, the audio sound emitted may be a song, tone, ring, or a recorded message. The audio sound is intended to be amusing, encouraging, and re-affirming to the small child. In another embodiment of the subject invention, the annunciating device may have an external volume control switch or dial operationally connected to the internal annunciator.

In another embodiment of the subject invention, the housing may contain a small internal microphone for recording a sound onto the circuit as a software audio file to be emitted by the internal annunciator.

In a further embodiment of the subject invention, the method further comprises the steps of: l) wirelessly transmitting a signal from wireless transmitter operationally coupled to the circuit each time the user-actuated button is pushed, to an electronic storage medium; m) storing the number of times the user-actuated button is pushed on the electronic storage medium; n) processing the number of times the user-actuated button is pushed with a processor operationally coupled to the electronic storage medium; o) generating a user-designed chart illustrating the number of time the user-actuated button is pushed; and p) monitoring these times to determine the success rate of the child.

In this embodiment of the subject invention, the electronic storage medium and processor may be a computer, a mobile computer pad, or a mobile smart phone.

The subject invention also discloses a method for toilet training a child comprising the steps of: a) providing a flush toilet comprising at least one exterior flat surface, and a toilet bowl having toilet bowl water therein; b) providing a portable, handheld annunciating device, wherein the annunciating device comprises a housing, a substantially flat bottom surface and a user-actuated button on the top surface, further wherein the substantially flat bottom surface comprises means for removably attaching the annunciating device to the exterior flat surface of the flush toilet; c) visually presenting and demonstrating the annunciating device to the child by pressing the user-actuated button within the child's sight, wherein pressing the button transmits a signal to an operationally coupled circuit contained within the housing to activate an internal annunciator to emit a vibration for the child to feel and hear; d) allowing the child to press the user-actuated button on the annunciating device to activate the internal annunciator to emit the vibration for the child to feel and hear; e) repeating steps c) and d) until the child associates the emitted vibration with pressing the user-actuated button; f) placing the annunciating device on the exterior flat surface of the flush toilet with the means for removably attaching the annunciating device, wherein the annunciating device is placed so as to allow the child to press the user-actuated button; g) encouraging the child to press the user-actuated button only upon completed urination or defecation into the toilet; h) allowing the child to attempt to urinate or defecate into the toilet when the child has the next urge to urinate or defecate; i) denying the child access to the user-actuated button except upon completion of urination or defecation into the toilet; j) allowing the child to press the user-actuated button on the annunciating device after the attempt; and k) providing a positive training stimulus to the child after the attempt to urinate or defecate into the toilet.

In other embodiments of the subject invention, the annunciating device may contain an internal power source electrically coupled to the circuit and the internal annunciator. In embodiments of the subject invention, the internal power source may be a battery.

In further embodiments of the subject invention, the internal annunciator may be a tactile transducer.

In a further embodiment of the subject invention, the method further comprises the steps of: l) wirelessly transmitting a signal from wireless transmitter operationally coupled to the circuit each time the user-actuated button is pushed, to an electronic storage medium; m) storing the number of times the user-actuated button is pushed on the electronic storage medium; n) processing the number of times the user-actuated button is pushed with a processor operationally coupled to the electronic storage medium; o) generating a user-designed chart illustrating the number of time the user-actuated button is pushed; and p) monitoring these times to determine the success rate of the child.

In this embodiment of the subject invention, the electronic storage medium and processor may be a computer, a mobile computer pad, or a mobile smart phone.

The subject invention further discloses a method for toilet training a child comprising the steps of: a) providing a flush toilet comprising at least one exterior flat surface, and a toilet bowl having toilet bowl water therein; b) providing a portable, handheld annunciating device, wherein the annunciating device comprises a housing, a substantially flat bottom surface and a user-actuated button on the top surface, further wherein the substantially flat bottom surface comprises means for removably attaching the annunciating device to the exterior flat surface of the flush toilet; c) visually presenting and demonstrating the annunciating device to the child by pressing the user-actuated button within the child's sight, wherein pressing the button transmits a signal to an operationally coupled circuit contained within the housing to activate an internal annunciator to emit a light for the child to see; d) allowing the child to press the user-actuated button on the annunciating device to activate the internal annunciator to emit the light for the child to see; e) repeating steps c) and d) until the child associates the emitted light with pressing the user-actuated button; f) placing the annunciating device on the exterior flat surface of the flush toilet with the means for removably attaching the annunciating device, wherein the annunciating device is placed so as to allow the child to press the user-actuated button; g) encouraging the child to press the user-actuated button only upon completed urination or defecation into the toilet; h) allowing the child to attempt to urinate or defecate into the toilet when the child has the next urge to urinate or defecate; i) denying the child access to the user-actuated button except upon completion of urination or defecation into the toilet; j) allowing the child to press the user-actuated button on the annunciating device after the attempt; and k) providing a positive training stimulus to the child after the attempt to urinate or defecate into the toilet.

In other embodiments of the subject invention, the annunciating device may contain an internal power source electrically coupled to the circuit and the internal annunciator. In embodiments of the subject invention, the internal power source may be a battery.

In further embodiments of the subject invention, the internal annunciator may be a visual transducer. In other embodiments of the subject invention, the visual transducer may be a light emitting diode.

In a further embodiment of the subject invention, the method further comprises the steps of: l) wirelessly transmitting a signal from wireless transmitter operationally coupled to the circuit each time the user-actuated button is pushed, to an electronic storage medium; m) storing the number of times the user-actuated button is pushed on the electronic storage medium; n) processing the number of times the user-actuated button is pushed with a processor operationally coupled to the electronic storage medium; o) generating a user-designed chart illustrating the number of time the user-actuated button is pushed; and p) monitoring these times to determine the success rate of the child.

In this embodiment of the subject invention, the electronic storage medium and processor may be a computer, a mobile computer pad, or a mobile smart phone.

The subject invention further discloses a method for toilet training a child comprising the steps of: a) providing a flush toilet comprising at least one exterior flat surface, and a toilet bowl having toilet bowl water therein; b) providing a portable, handheld annunciating device, wherein the annunciating device comprises a housing, a substantially flat bottom surface and a user-actuated button on the top surface, further wherein the substantially flat bottom surface comprises means for removably attaching the annunciating device to the exterior flat surface of the flush toilet; c) visually presenting and demonstrating the annunciating device to the child by pressing the user-actuated button within the child's sight, wherein pressing the button transmits a signal to an operationally coupled circuit contained within the housing to activate an internal annunciator to emit a combination of an audible sound, a vibration and a visible light for the child to hear, feel and see; d) allowing the child to press the user-actuated button on the annunciating device to activate the internal annunciator; e) repeating steps c) and d) until the child associates the emitted audible sound, vibration and light with pressing the user-actuated button; f) placing the annunciating device on the exterior flat surface of the flush toilet with the means for removably attaching the annunciating device, wherein the annunciating device is placed so as to allow the child to press the user-actuated button; g) encouraging the child to press the user-actuated button only upon completed urination or defecation into the toilet; h) allowing the child to attempt to urinate or defecate into the toilet when the child has the next urge to urinate or defecate; i) denying the child access to the user-actuated button except upon completion of urination or defecation into the toilet; j) allowing the child to press the user-actuated button on the annunciating device after the attempt; and k) providing a positive training stimulus to the child after the attempt to urinate or defecate into the toilet.

In other embodiments of the subject invention, the annunciating device may contain an internal power source electrically coupled to the circuit and the internal annunciator. In embodiments of the subject invention, the internal power source may be a battery.

In further embodiments of the subject invention, the internal annunciator may be a combination of an audible transducer, a visual transducer and a tactile transducer. In other embodiments of the subject invention, the visual transducer may be a light emitting diode.

In a further embodiment of the subject invention, the annunciating device may have an external switch operationally coupled to the circuit, wherein the switch allows a user to select whether the audible transducer, visual transducer, tactile transducer, or any combination of these three is activated once the user-actuated button is pressed.

In a further embodiment of the subject invention, the audio sound emitted may be a song, tone, ring, or a recorded message. The audio sound is intended to be amusing, encouraging, and re-affirming to the small child. In another embodiment of the subject invention, the annunciating device may have an external volume control switch or dial operationally connected to the internal annunciator.

In another embodiment of the subject invention, the housing may contain a small internal microphone for recording a sound onto the circuit as a software audio file to be emitted by the internal annunciator.

In a further embodiment of the subject invention, the method further comprises the steps of: l) wirelessly transmitting a signal from wireless transmitter operationally coupled to the circuit each time the user-actuated button is pushed, to an electronic storage medium; m) storing the number of times the user-actuated button is pushed on the electronic storage medium; n) processing the number of times the user-actuated button is pushed with a processor operationally coupled to the electronic storage medium; o) generating a user-designed chart illustrating the number of time the user-actuated button is pushed; and p) monitoring these times to determine the success rate of the child.

In this embodiment of the subject invention, the electronic storage medium and processor may be a computer, a mobile computer pad, or a mobile smart phone.

The subject invention further discloses a method for toilet training a child comprising the steps of: a) providing a child training toilet comprising at least one exterior flat surface; b) providing a portable, handheld annunciating device, wherein the annunciating device comprises a housing, a substantially flat bottom surface and a user-actuated button on the top surface, further wherein the substantially flat bottom surface comprises means for removably attaching the annunciating device to the exterior flat surface of the training toilet; c) visually presenting and demonstrating the annunciating device to the child by pressing the user-actuated button within the child's sight, wherein pressing the button transmits a signal to an operationally coupled circuit contained within the housing to activate an internal annunciator to emit a combination of an audible sound, a vibration and a visible light for the child to hear, feel and see; d) allowing the child to press the user-actuated button on the annunciating device to activate the internal annunciator; e) repeating steps c) and d) until the child associates the emitted audible sound, vibration and light with pressing the user-actuated button; f) placing the annunciating device on the exterior flat surface of the training toilet with the means for removably attaching the annunciating device, wherein the annunciating device is placed so as to allow the child to press the user-actuated button; g) encouraging the child to press the user-actuated button only upon completed urination or defecation into the training toilet; h) allowing the child to attempt to urinate or defecate into the training toilet when the child has the next urge to urinate or defecate; i) denying the child access to the user-actuated button except upon completion of urination or defecation into the training toilet; j) allowing the child to press the user-actuated button on the annunciating device after the attempt; and k) providing a positive training stimulus to the child after the attempt to urinate or defecate into the training toilet.

In a further embodiment of the subject invention, the method further comprises the steps of: l) wirelessly transmitting a signal from wireless transmitter operationally coupled to the circuit each time the user-actuated button is pushed, to an electronic storage medium; m) storing the number of times the user-actuated button is pushed on the electronic storage medium; n) processing the number of times the user-actuated button is pushed with a processor operationally coupled to the electronic storage medium; o) generating a user-designed chart illustrating the number of time the user-actuated button is pushed; and p) monitoring these times to determine the success rate of the child.

In this embodiment of the subject invention, the electronic storage medium and processor may be a computer, a mobile computer pad, or a mobile smart phone.

In other embodiments of the subject invention, the annunciating device may contain an internal power source electrically coupled to the circuit and the internal annunciator. In embodiments of the subject invention, the internal power source may be a battery.

In further embodiments of the subject invention, the internal annunciator may be a combination of an audible transducer, a visual transducer and a tactile transducer. In other embodiments of the subject invention, the visual transducer may be a light emitting diode.

In another embodiment of the subject invention, the annunciating device may have an external switch operationally coupled to the circuit, wherein the switch allows a user to select whether the audible transducer, visual transducer, tactile transducer, or any combination of these three is activated once the user-actuated button is pressed.

In one embodiment of the subject invention, the audio sound emitted may be a song, tone, ring, or a recorded message. The audio sound is intended to be amusing, encouraging, and re-affirming to the small child. In another embodiment of the subject invention, the annunciating device may have an external volume control switch or dial operationally connected to the internal annunciator.

In another embodiment of the subject invention, the housing may contain a small internal microphone for recording a sound onto the circuit as a software audio file to be emitted by the internal annunciator.

In further embodiments of the subject invention, the exterior flat surface of the flush toilet may be a side surface of a toilet tank, a top surface of a toilet tank lid or a surface of the toilet bowl.

In other embodiments of the subject invention, the means for removably attaching the annunciating or electronic device to the exterior flat surface of the toilet may be a plurality of suction cups, adhesive strips, VELCRO®, double-stick tape, or a hook attached to a toilet tank lid.

In further embodiments of the subject invention, the annunciating or electronic device is waterproof. In further embodiments of the subject invention, the annunciating or electronic device is composed of plastic materials.

In other embodiments of the subject invention, the user-actuated button comprises permanent indicia.

In further embodiments of the subject invention, the base housing, bottom surface and user-actuated button all may have a shape that is substantially circular, substantially trapezoid, substantially square, substantially triangular, substantially octagonal or substantially hexagonal.

In other embodiments of the subject invention, the annunciating or electronic device may be ½ inch to eight inches in diameter and ¼ to three inches in height.

In another embodiment of the subject invention, the housing may comprise an external outlet, such as an USB outlet, for operationally connecting the circuit or controller to an external computer, mobile computer pad, or a mobile smart phone. The circuit or controller may contain a software program that allows a user to install a user-selected software audio file onto the circuit or controller from the external computer, mobile computer pad, or a mobile smart phone. This software audio file may be the generated sensory output.

In a further embodiment of the subject invention, the housing may comprise a wireless receiver, for operationally connecting the circuit or controller to an external computer, mobile computer pad, or a mobile smart phone. The circuit or controller may contain a software program that allows a user to wirelessly install a user-selected software audio file onto the circuit or controller from the external computer, mobile computer pad, or a mobile smart phone. This software audio file may be the generated sensory output.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto. These together with other objects of the invention, along with the various features of novelty, which characterize the invention, are pointed out with particularity in the claims annexed to and forming a part of this disclosure.

### BRIEF DESCRIPTION OF THE DRAWINGS

Advantages of the present invention will be apparent from the following detailed description of embodiments thereof, which description should be considered in conjunction with the accompanying drawings, in which:

FIG. 1 illustrates a perspective view of one embodiment of the annunciating device of the potty training method.

FIG. 2 illustrates a side view of one embodiment of the annunciating device attached to the toilet tank of a standard flush toilet.

FIG. 3 illustrates a side view of one embodiment of the annunciating device attached to the toilet bowl of a standard flush toilet.

FIG. 4 illustrates a side view of one embodiment of the annunciating device attached to the toilet tank lid of a standard flush toilet.

FIG. 5 is a schematic illustration of the electronic unit illustrated in FIG. 1.

FIG. 6 illustrates a sample graph created from transmitted data from the annunciating device.

FIG. 7 illustrates a perspective view of another embodiment of the annunciating device of the potty training method.

FIG. 8 illustrates a perspective view of a further embodiment of the annunciating device of the potty training method.

FIG. 9 illustrates a perspective view of another embodiment of the annunciating device with attachment devices.

### DETAILED DESCRIPTION OF THE PREFERRED EMBODIMENTS

While several variations of the present invention have been illustrated by way of example in particular embodiments, it is apparent that further embodiments could be developed within the spirit and scope of the present invention, or the inventive concept thereof. It is to be expressly understood that such modifications and adaptations are within the spirit and scope of the present invention.

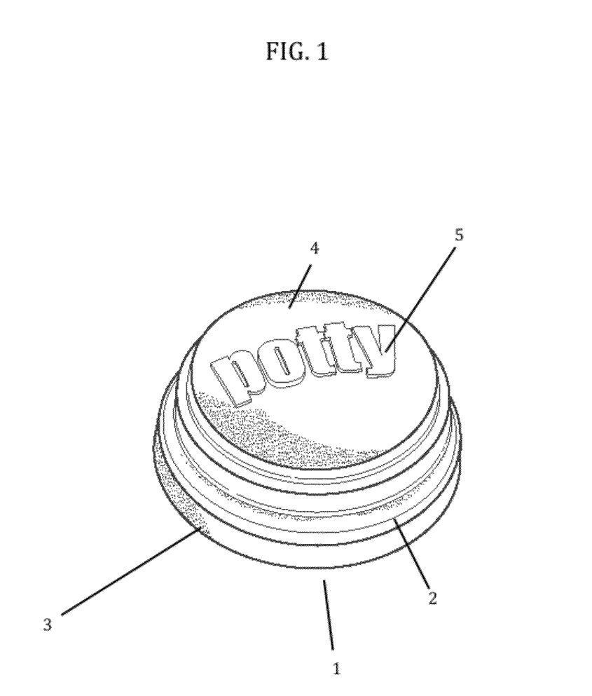

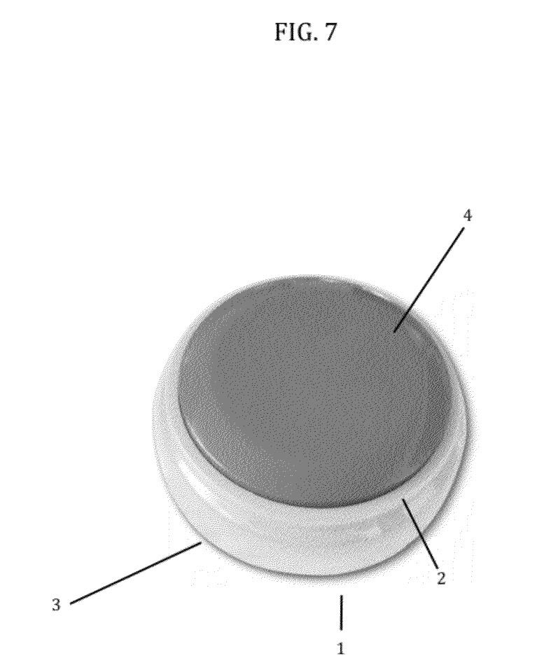

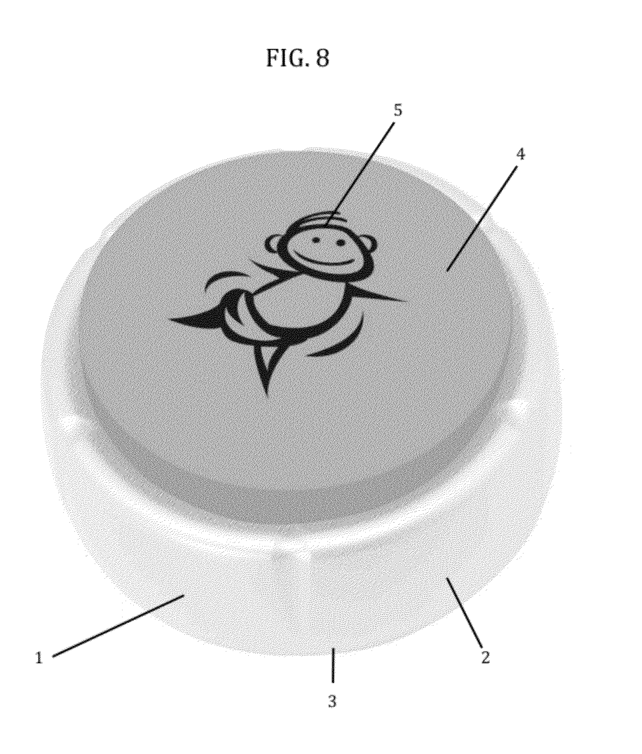

FIGS. 1, 5, and 7-9 illustrate embodiments of the annunciating device 1 used in the potty training method of the subject invention. This annunciating device 1 is a portable handheld electronic device, substantially the size of other handheld electronic devices.

The annunciating device 1 comprises a base housing 2, a substantially flat bottom surface 3 and a user-actuated button 4. In one embodiment of the subject invention, the user-actuated button 4 comprises permanent indicia 5. As shown in FIG. 1, these indicia 5 may comprise the word “potty.”

The base housing 2, bottom surface 3 and user-actuated button 4 all may have a substantially circular shape as shown. In other embodiments of the subject invention, the base housing 2, bottom surface 3 and user-actuated button 4 may have other shapes including, but not limited to: trapezoid, square, circle, triangle, octagon or hexagon (not shown).

In embodiments of the subject invention, the annunciating device 1 may be ½ inch to eight inches in diameter and ¼ to three inches in height.

In another embodiment of the subject invention, the annunciating device 1 is made out of plastic that has been set in a mold. In a further embodiment of the subject invention, the annunciating device 1 is waterproof.

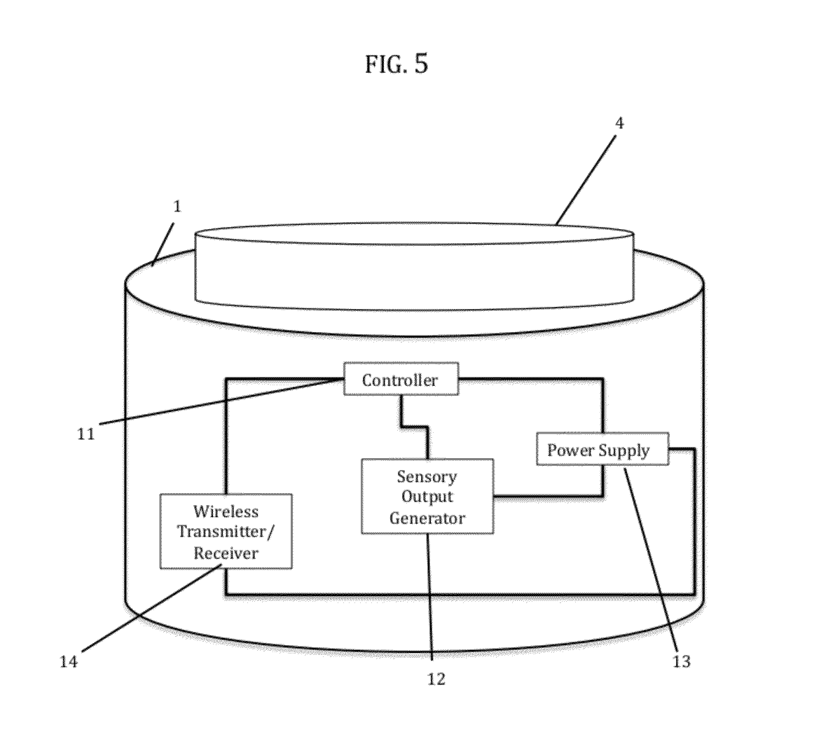

As shown in FIG. 5, the annunciating device 1 may contain an electrical controller 11 operationally connected to an internal power supply 13 and a sensory output generator 12. The sensory output generator 12 may generate an audible sound, a visible light, a vibration or a combination thereof when the user-actuated button 4 is pressed.

In another embodiment of the subject invention, the housing may comprise an external outlet, such as an USB outlet, for operationally connecting the circuit or controller to an external computer, mobile computer pad, or a mobile smart phone. The circuit or controller 11 may contain a software program that allows a user to install a user-selected software audio file onto the circuit or controller 11 from the external computer, mobile computer pad, or a mobile smart phone. This software audio file may be the generated sensory output.

In another embodiment of the subject invention, the housing may comprise a wireless transmitter/receiver 14, for operationally connecting the circuit or controller to an external computer, mobile computer pad, or a mobile smart phone. The circuit or controller may contain a software program that allows a user to wirelessly install a user-selected software audio file onto the circuit or controller from the external computer, mobile computer pad, or a mobile smart phone. This software audio file may be the generated sensory output.

In a further embodiment of the subject invention, the base housing 2 may contain a small internal microphone for recording a sound onto the circuit as a software audio file. In one embodiment of the subject invention, the total recording time of the circuit may be thirty (30) seconds.

In one embodiment of the subject invention, the base housing 2 may include a volume control switch or control dial operationally connected to the audio annunciator. The volume control switch may adjust the sound volume from 0 to 95 dB.

The internal power supply 13 of the annunciating device 1 may be a replaceable standard or rechargeable battery. In one embodiment of the subject invention, the annunciating device 1 may have an outlet for connecting the internal power supply 13 to a cord for selectively connecting to an electrical outlet.

In a further embodiment of the subject invention, the annunciating device 1 may have an internal LED annunciator or LED lights operationally coupled to the internal power supply 13 and the controller 11. When a user presses button 4, a signal is transmitted to the controller 11 that causes the LED annunciator to emit one or more lights.

In another embodiment of the subject invention, the annunciating device 1 may have a vibration element operationally coupled to the internal power supply 13 and the controller 11. When a user presses button 4, a signal is transmitted to the controller 11 that causes the vibration element to emit vibrations.

In a further embodiment, the annunciating device 1 may have a switch that allows a user to select whether the audio annunciator, the LED annunciator, the vibration element, or any combination of these three is activated once a user presses button 4. In this embodiment, a user may either cause the annunciating device 1 to produce sound, vibrate or emit light separately or at the same time upon pressing button 4.

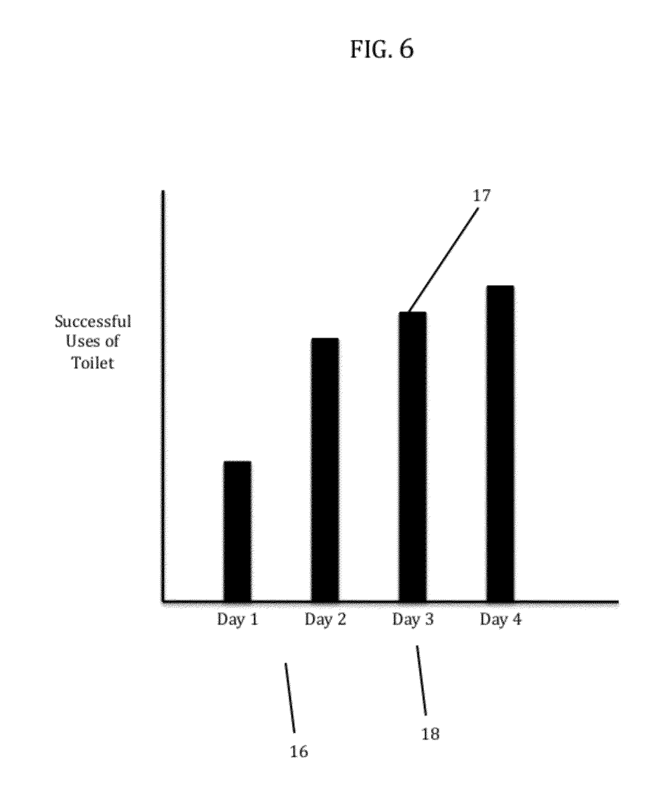

In a further embodiment, the annunciating device 1 may contain a transmitter 14 for sending a wireless signal to an external electronic component that makes a record that the annunciating device was activated, and how many times it was activated. This external electronic component processes this data and generates a user-designed graph 16, as shown in FIG. 6, that illustrates the number of uses 17 of the button 4 over a set number of days 18. An adult may monitor these times with the easy to read graph 16 to determine the success rate of the child. In one embodiment, this external electronic component may be an external computer, a mobile computer pad, or a mobile smart phone.

An adult raising a child begins the method of the subject invention by demonstrating the annunciating device 1 to the small child. The adult presses the button 4 to emit the selected audio, lighting or vibration. The adult then allows the child to press the button one or more times to emit the selected audio, lighting or vibration. The adult explains to the child that pressing the button will be a reward for attempting to use the standard flush or child-sized toilet. The child and the adult may then select the desired audio, lights or vibration to be emitted once button 4 is pushed.

The adult and the child then select the desired location, preferably proximate to or on a standard flush toilet, within reach of the small child.

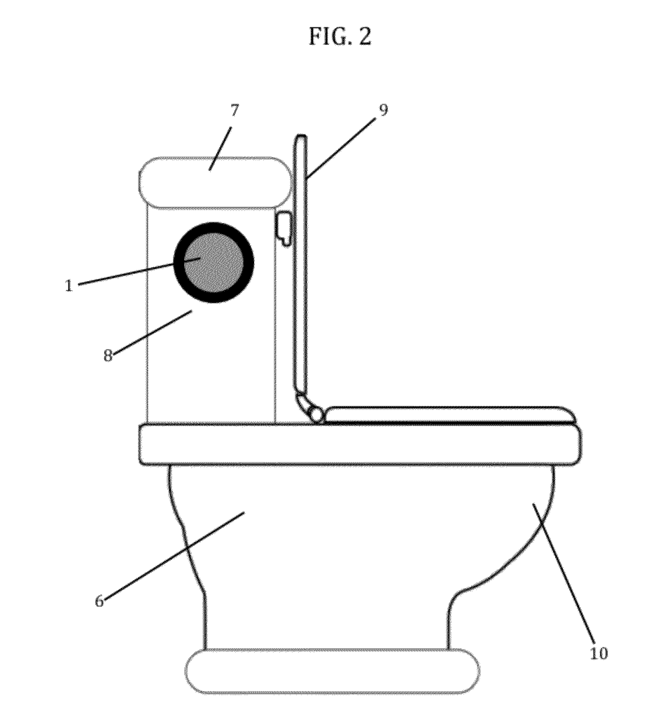

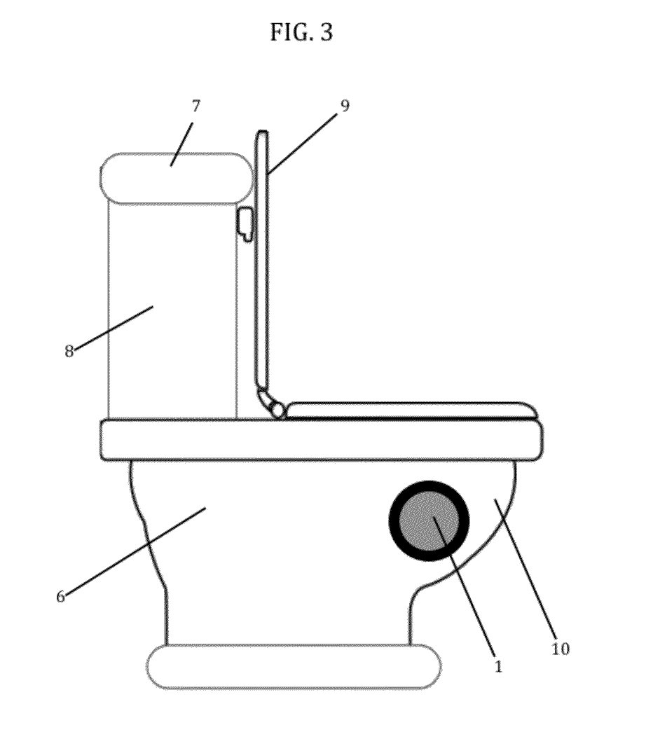

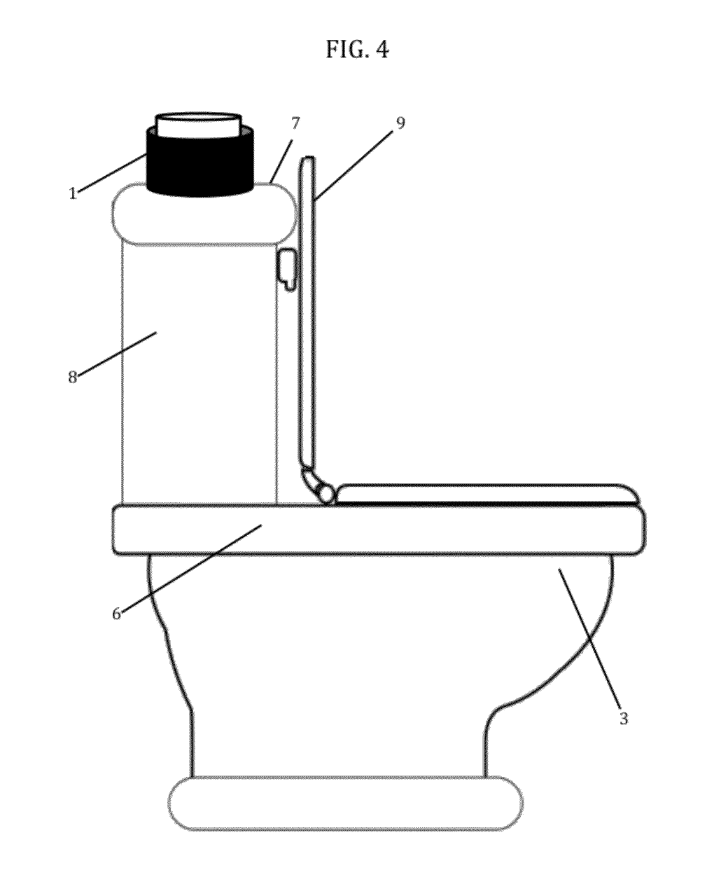

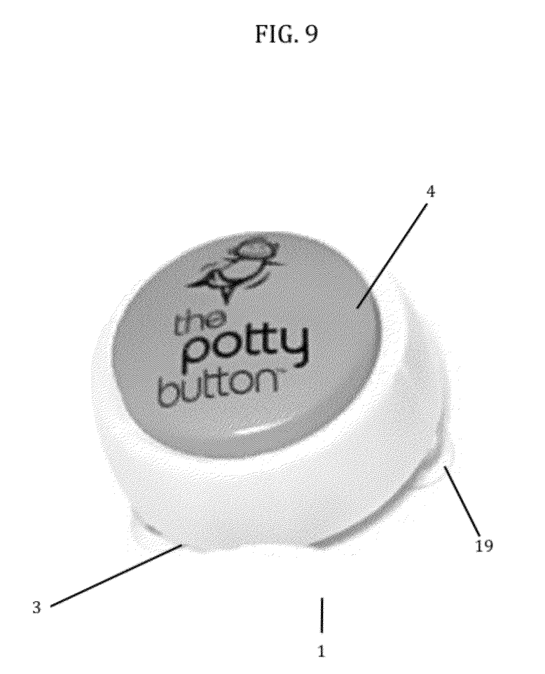

The bottom surface 3 may comprise a means for removably attaching the annunciating device 1 to various locations onto or proximate to a standard flush toilet 6 (shown in FIGS. 2, 3 and 4). This attaching means may be one or more suction cups 19 (shown in FIG. 9), adhesive strips, VELCRO®, double-stick tape or a hook attached to a toilet tank lid 7. As illustrated in FIGS. 2, 3 and 4, the annunciating device 1 may be placed on a toilet lid 9, a toilet tank 8, a toilet tank lid 7, a toilet bowl 10, a wall adjacent to the toilet, a countertop adjacent to the toilet or a cabinet adjacent to the toilet.

Each time the child attempts to use the standard flush toilet or potty chair, they are allowed to press button 4 at least once, if not multiple times. Each time the button 4 is pressed, the device 1 sends a wireless signal to an external electronic component or an external computer that records the exact times the button 4 was pressed. The adult may monitor these recorded times to determine the success rate of the child.

In one embodiment of the subject invention, the audio file emitted may be a song, tone, ring, or a recorded message. The audio sound is intended to be amusing, encouraging, and re-affirming to the small child.

The subject invention discloses a method for potty training a small child comprising the steps of: a) placing an annunciating device on an exterior surface of a standard flush toilet or child-sized toilet, wherein the annunciating device comprises a housing, a substantially flat bottom surface and a user-actuated button on the top surface, further wherein substantially flat bottom surface comprises means for removably attaching the annunciating device; b) allowing the small child to attempt to use the toilet; and c) allowing the child to press the user-actuated button on the annunciating device after the attempt, wherein pressing the button transmits a signal to an operationally couple circuit contained within the annunciating device to activate an internal annunciator.

What is claimed is:

1. A method for toilet training a child comprising the steps of:
a) providing a flush toilet comprising at least one exterior flat surface, and a toilet bowl having toilet bowl water therein;
b) providing a portable, handheld electronic device, wherein the electronic device comprises a housing, a substantially flat bottom surface and a user-actuated button on the top surface, further wherein the substantially flat bottom surface comprises means for removably attaching the electronic device to the exterior flat surface of the flush toilet;
c) visually presenting and demonstrating the electronic device to the child by pressing the user-actuated button within the child's sight, wherein pressing the button transmits a signal to an operationally coupled controller contained within the housing to activate an internal sensory output generator, wherein the sensory output generator generates a sensory output to the child;
d) allowing the child to press the user-actuated button on the electronic device to activate the internal sensory output generator to generate the sensory output for the child;
e) repeating steps c) and d) until the child associates the sensory output with pressing the user-actuated button;
f) placing the electronic device on the exterior flat surface of the flush toilet with the means for removably attaching the electronic device, wherein the electronic device is placed so as to allow the child to press the user-actuated button;
g) encouraging the child to press the user-actuated button only upon completed urination or defecation into the toilet;
h) allowing the child to attempt to urinate or defecate into the toilet when the child has the next urge to urinate or defecate;
i) denying the child access to the user-actuated button except upon completion of urination or defecation into the toilet;
j) allowing the child to press the user-actuated button on the electronic device after the attempt; and
k) providing a positive training stimulus to the child after the attempt to urinate or defecate into the toilet.

2. The method of claim 1, further comprising the steps of:
l) wirelessly transmitting a signal from wireless transmitter operationally coupled to the controller each time the user-actuated button is pushed, to an electronic storage medium;
m) storing the number of times the user-actuated button is pushed on the electronic storage medium;
n) processing the number of times the user-actuated button is pushed with a processor operationally coupled to the electronic storage medium;
o) generating a user-designed chart illustrating the number of time the user-actuated button is pushed; and
p) monitoring these times to determine the success rate of the child.

3. The method of claim 2, wherein the electronic storage medium and processor may comprise a single device selected from the group consisting of a desktop computer, a laptop computer, a mobile computer pad, and a mobile smart phone.

4. The method of claim 1, wherein the sensory output generator may comprise a transducer selected from the group consisting of an audible transducer, a visual transducer, and a tactile transducer.

5. The method of claim 1, wherein, the means for removably attaching the electronic device to the exterior flat surface of the toilet may comprise a device selected from the group consisting of a plurality of suction cups, a plurality adhesive strips, a plurality VELCRO® strips, double-stick tape, and a hook attached to a toilet tank lid.

6. The method of claim 1, wherein the electronic device is substantially waterproof.

7. The method of claim 1, wherein the user-actuated button comprises permanent indicia.

8. The method of claim 1, wherein the housing, the bottom surface and the user-actuated button all comprise a shape selected from the group consisting of substantially circular, substantially trapezoid, substantially square, substantially triangular, substantially octagonal and substantially hexagonal.

9. The method of claim 1, wherein the electronic device further comprises a battery electrically coupled to the controller.

10. The method of claim 1, wherein the exterior flat surface of the flush toilet may comprise a surface selected from the group consisting of a side surface of a toilet tank, a top surface of a toilet tank lid, and a side surface of a toilet bowl.

11. The method of claim 1, wherein the sensory output may comprise an audible sound selected from the group consisting of a song, tone, ring, and a recorded message.

12. The method of claim 1, wherein the sensory output may comprise a vibration.

13. The method of claim 1, wherein the sensory output may comprise a visible light.

14. The method of claim 1, wherein the housing further comprises a small internal microphone for recording a sound onto the controller to be stored as a software audio file to be emitted by the sensory output generator.

15. The method of claim 1, wherein the housing further comprises a USB outlet for operationally connecting the controller to an external computing device.

16. The method of claim 1, wherein the housing further comprises a wireless receiver for operationally connecting the controller to an external computing device.
